(19) United States
(12) Patent Application Publication
(10) Pub. No.: US 2024/0070663 A1
(43) Pub. Date: Feb. 29, 2024

(54) DATA CIRCULATION SUPPORT APPARATUS, DATA CIRCULATION SUPPORT METHOD AND PROGRAM

(71) Applicant: NIPPON TELEGRAPH AND TELEPHONE CORPORATION, Tokyo (JP)

(72) Inventors: Shigenori OHASHI, Tokyo (JP); Atsushi NAKADAIRA, Tokyo (JP); Shigeru FUJIMURA, Tokyo (JP); Keita SUZUKI, Tokyo (JP); Honoka TODA, Tokyo (JP)

(21) Appl. No.: 18/261,913

(22) PCT Filed: Jan. 22, 2021
(86) PCT No.: PCT/JP2021/002212

§ 371 Date: Jul. 18, 2023

(51) Int. Cl. G06Q 20/38; G06Q 20/40

(52) U.S. Cl. CPC G06Q 20/389; G06Q 20/403; G06Q 40/03

(57) ABSTRACT

A data circulation support apparatus includes a memory and a processor configured to execute calculating a score indicating reliability of a contract condition related to circulation of data based on information indicating a sense of value related to contract compliance of each of a user of a circulation source of the data and a user of a circulation destination of the data, and to identifying a contract condition whose score is greater than or equal to a threshold; and recording the contract condition in a ledger upon receiving information indicating approval to the contract condition by the user of the circulation source or the circulation destination.

### TECHNICAL FIELD

The present invention relates to a data circulation support apparatus, a data circulation support method, and a program.

### BACKGROUND ART

In the data circulation market, it is expected to circulate data more deeply related to people such as personal data in the future.

Conventionally, in the case of dealing data, a contract is exchanged between parties concerned, and when the parties concerned agree with each other, a consideration is paid.

In addition, conventionally, a method for executing agreement of a contract by using a blockchain has been proposed (for example, PTL 1).

Also, a method for permitting the use of contents under agreement of a contract has been proposed (for example, PTL 2).

Also, when the contract is concluded, there is a mechanism for determining whether or not to conclude a contract by using the credit information of the opposite party (information on the application or contract of credit, loan or the like, the payment state, the balance or the like).

### CITATION LIST

### Patent Literature

[PTL 1] Japanese Patent No. 6511017
[PTL 2] Japanese Patent No. 6452156

### SUMMARY OF INVENTION

### Technical Problem

However, the existing credit information is mainly information on payment, and is poor as information for determining the possibility that data circulation is abused.

The present invention has been made in view of the foregoing, and an object of the present invention is to reduce the possibility that data circulation is abused.

### Solution to Problem

In order to solve the above problem, a data circulation support apparatus includes:
an identification unit configured to calculate a score indicating reliability to a contract condition related to circulation of data based on information indicating a sense of value related to contract compliance of each of a user of a circulation source of the data and a user of a circulation destination of the data, and to identify a contract condition for which the score is greater than or equal to a threshold value; and
a recording processing unit configured to record the contract condition in a ledger when receiving information indicating approval to the contract condition by the user of the circulation source or the circulation destination.

### Advantageous Effects of Invention

The possibility that data circulation is abused can be reduced.

### BRIEF DESCRIPTION OF DRAWINGS

FIG. 1 is a diagram showing a configuration example of a circulation system in an embodiment of the present invention.

FIG. 2 is a diagram showing a configuration example of hardware of a data circulation intermediary device 10 in the embodiment of the present invention.

FIG. 3 is a diagram showing an example of a functional configuration of a value sense calculation device 20 in the embodiment of the present invention.

FIG. 4 is a diagram showing an example of a functional configuration of the data circulation intermediary device 10 in the embodiment of the present invention.

FIG. 5 is a diagram showing an example of the difference in properties of three types of ledgers.

FIG. 6 is a sequence diagram for explaining an example of processing steps which is executed in a data circulation system.

### DESCRIPTION OF EMBODIMENTS

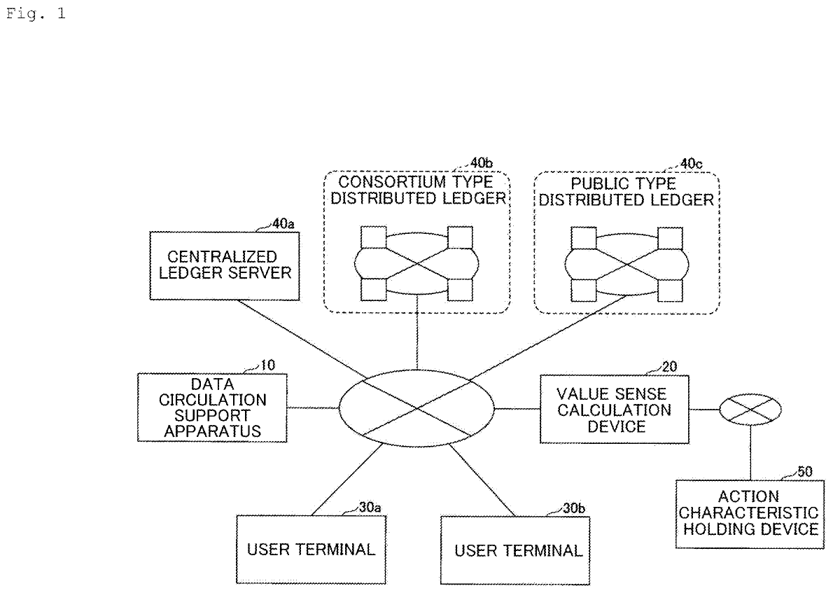

Embodiments of the present invention will be described below with reference to the accompanying drawings. FIG. 1 is a diagram showing an example of the configuration of a data circulation system according to an embodiment of the present invention. As shown in FIG. 1, the data circulation system includes a data circulation intermediary device 10, a value sense calculation device 20, a user terminal 30a and a user terminal 30b (herein after, when they are not distinguished from each other, it is simply called “user terminal 30”), a centralized ledger server 40a, a consortium type distributed ledger 40b, a public type distributed ledger 40c, and an action characteristic holding device 50.

The data circulation intermediary device 10, the value sense calculation device 20, the user terminal 30a and the user terminal 30b, the centralized ledger server 40a, and the consortium type distributed ledger 40b and the public type distributed ledger 40c are connected by a network such as the Internet and can communicate with each other. The value sense calculation device 20 is connected to the action characteristic holding device 50 via a communication network. Note that, when the consortium type distributed ledger 40b and the public type distributed ledger 40c are not distinguished, they are simply referred to as “distributed ledger(s)”. When the centralized ledger server 40a is not distinguished from the distributed ledger, it is simply called a “ledger”.

The user terminal 30 is a terminal such as a PC (Personal computer), a smart phone, or a tablet terminal used by a user related to circulation of data (for example, trade). In this embodiment, the user terminal 30a is a user terminal 30 used by a user A who is a providing source (circulation source) of target data of circulation (herein after referred to as “target data”). On the other hand, the user terminal 30b is a user terminal 30 used by a user B who is provided with the data (circulation destination).

For parties of data circulation (in the embodiment of the present invention, refers to the user A and the user B), the value sense calculation device 20 is a plurality of computers which calculate data (herein after referred to as “value sense data”) indicating sense of values (herein after simply referred to as “value sense”) on (a contract of) data circulation. The value sense data of each user is calculated based on the action characteristic data of each user. The action characteristic data of a certain user refers to data indicating the action characteristic of the certain user. The details of the parameters which may constitute the action characteristic data will be described later. The value sense calculation device 20 has access functions to a user terminal 30, an action characteristic holding device 50, various ledgers (centralized ledger server 40a, consortium type distributed ledger 40b, and the public type distributed ledger 40c). When a secret key is required for such access, the value sense calculation device 20 holds the secret key under the management of the device itself.

The data circulation intermediary device 10 is a plurality of computers configured to, based on the value sense data of each user calculated by the value sense calculation device 20, calculate an index indicating reliability (herein after referred to as “reliability score”) of a contract related to contract conditions regarding the circulation of target data (data circulation). The reliability score is an index indicating the level of the possibility that the contract is observed, for example, a scalar value between 0 and 100, indicating that the reliability is higher as the value is greater. The data circulation intermediary device 10 identifies a contract condition whose reliability score is greater than or equal to a threshold, and presents the contract condition to a user terminal 30 related to the data circulation. The threshold value varies depending on, for example, meta-information on the target data (herein after referred to as “data information”). The data circulation intermediary device 10 has an access function to the centralized ledger server 40a and each distributed ledger. When a secret key is required for such access, the data circulation intermediary device 10 holds the secret key under the management of the device itself.

The action characteristic holding device 50 is an example of a device for storing action characteristic data of each of a plurality of users (a plurality of users not limited to user A and user B). The action characteristic holding device 50 is operated by, for example, a company holding action characteristic data of each user via some method (for example, some service), or an information bank.

Each ledger functions as a storage device (storage unit) for storing contract contents related to data circulation.

The number of the centralized ledger server 40a, each distributed ledger, the action characteristic holding device 50, and the user terminal 30 is not limited to the number exemplified in FIG. 1, and a plurality of the respective devices may exist.

The value sense calculation device 20 and the data circulation intermediary device 10 may be configured (for example, as one device) by using the same computer.

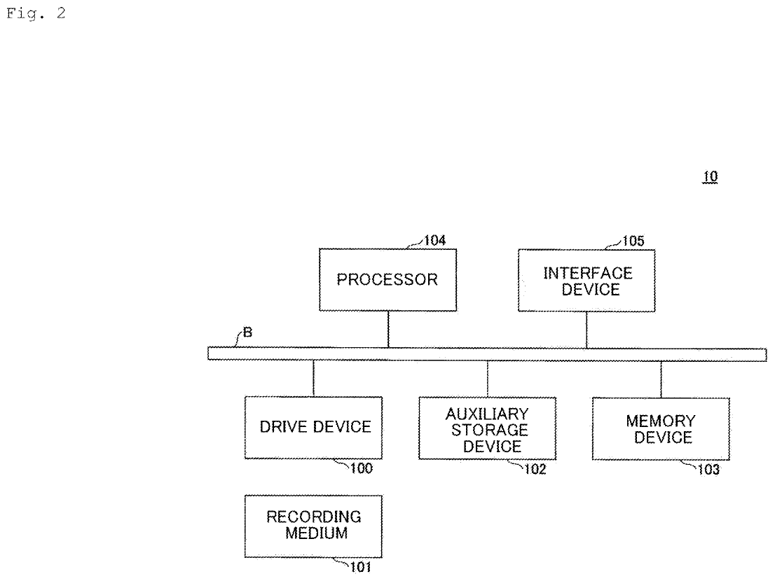

FIG. 2 is a diagram showing a hardware configuration example of the data circulation intermediary device 10 in the embodiment of the present invention. The data circulation intermediary device 10 of FIG. 2 includes a drive device 100, an auxiliary storage device 102, a memory device 103, a processor 104, an interface device 105, and the like which are connected to each other through a bus B.

A program for implementing processing in the data circulation intermediary device 10 is provided by a recording medium 101 such as a CD-ROM. When the recording medium 101 storing the program is set in the drive device 100, the program is installed from the recording medium 101 to the auxiliary storage device 102 via the drive device 100. However, the program does not need to be installed from the recording medium 101, and may be downloaded from another computer through a network. The auxiliary storage device 102 stores the installed program and also stores necessary files, data, and the like.

When an instruction to activate the program is issued, the memory device 103 reads the program from the auxiliary storage device 102 and stores the program. The processor 104 is a CPU or a GPU (Graphics Processing Unit), or a CPU and a GPU, to execute a function related to the data circulation intermediary device 10 in accordance with the program stored in the memory device 103. The interface device 105 is used as an interface to connect to a network.

The value sense calculation device 20 may also have a hardware configuration similar to that of FIG. 2.

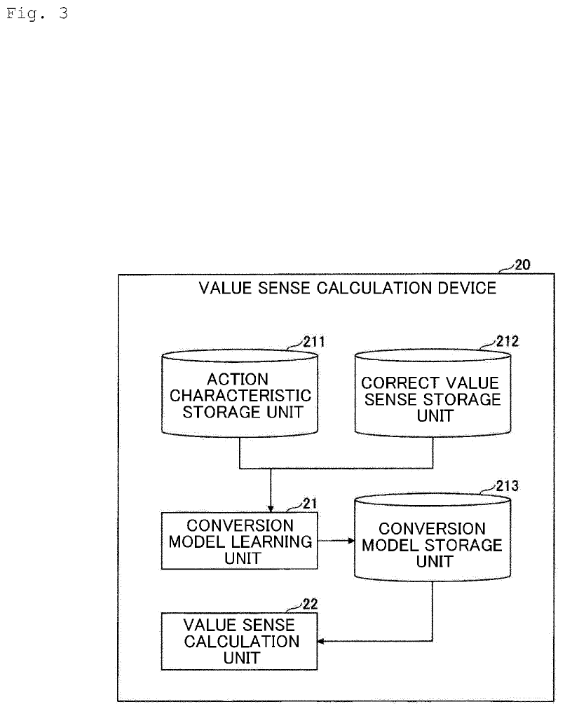

FIG. 3 is a diagram showing a functional configuration example of the value sense calculation device 20 in the embodiment of the present invention. Referring to FIG. 3, the value sense calculation device 20 includes a conversion model learning unit 21 and a value sense calculation unit 22. These functional units are implemented through processing that one or more programs installed in the value sense calculation device 20 cause the processor of the value sense calculation device 20 to execute. The value sense calculation device 20 also uses an action characteristic storage unit 211, a correct value sense storage unit 212, and a conversion model storage unit 213. Each of these storage units can be implemented by using a storage device of the value sense calculation device 20, or a storage device that can be connected to the value sense calculation device 20 or the like via a network.

The action characteristic storage unit 211 stores action characteristic data of each of a plurality of (many) users for each user. The action characteristic data includes, for example, one or more items of data among data indicating a purchase tendency of a user, data indicating a tendency of an action range of the user, data indicating a type of SNS (Social Networking Service) used by the user, and data indicating whether a transmission side tendency or a reception side tendency of the SNS, as a parameter.

The data indicating the purchase tendency is, for example, data indicating whether it is a tendency to take a purchase action avoiding a monetary loss or a tendency to take a purchase action giving priority to time and function over a slight monetary loss. The data indicating the purchase tendency may be derived from data indicating the purchase history of the user, for example.

The data indicating the tendency of the action range is data indicating whether the same action pattern can be easily seen, whether the action pattern is largely changed depending on the case, or whether the action range has a large number of popular places on an SNS or the like. The data indicating the tendency of the action range may be derived from, for example, a history of the positional information.

Note that the values of the respective parameters are expressed by, for example, a real value between 0 and 1. For example, the data indicating the purchase tendency may be set to a value close to 0 if the tendency to take the purchase action avoiding the monetary loss is stronger, and may be set to a value close to 1 if the tendency to take the purchase action giving priority to time and function is stronger than some monetary loss.

The action characteristic data may be provided from each user terminal 30, or may be provided from an action characteristic holding device 50, or may be acquired from each ledger.

The parameters of the action characteristic data are not limited to those exemplified above. However, as will be described later, the action characteristic data is used for deriving data (herein after, referred to as “values sense data”) indicating sense of values (herein after, simply referred to as “values sense”) related to (contract of) data circulation (or used for conversion to value sense data). Therefore, it is desirable that the action characteristic data is data suitable for deriving the value sense data (correlated with value sense).

The value sense data is multi-dimensional data composed of parameters such as “consistency tendency of action”, “degree of influence from reputation from others”, and “degree of influence from monetary merits or demerits”.

The “consistency tendency of action” means a degree of containing in himself or herself what is generally referred to as the principle of consistency. A person has a tendency to observe his or her utterance. That is, there is a tendency to dislike self-contradiction in a person. However, there are persons who are strong in the character and persons who are weak in the character. The “consistency tendency of action” means the degree of the character.

The “degree of influence received from reputation from others” refers to a degree of a person's tendency to care about how others perceive himself or herself. It is considered that a person who has a strong tendency to care about evaluation from others is likely to take the evaluation as an incentive.

The “degree of influence from the monetary merit or demerit” means a degree of worrying about a monetary reward or loss. If a person strongly dislikes a monetary loss, the deposit (a guaranteed money automatically accepted by the opposite party when the trade contract fails) may become a large element for changing the action. However, for persons who do not worry about monetary loss unless the amount of money is significantly large, it is considered that the deposit does not have much influence on changing the action.

The value of each parameter of the value sense data is expressed by, for example, a real value between 0 and 1.

It is difficult to control data off line by electronic technology, and large part depends on the ethics of the parties concerned. The value sense data is introduced in the present embodiment based on an idea that for data circulation that does not lead to further abuse, information on value sense, which is the degree of contractual compliance, is required.

The correct value sense storage unit 212 stores data indicating an investigation result of a value sense performed in advance for a plurality of (many) users (that is, a correct value sense of each user), (herein after, referred to as “correct value sense data”) for each user. The investigation of the value sense to the user is performed by making the user write answers on a sheet on which a plurality of questions for asking the value sense are described. The correct value sense data is obtained by converting the contents of the answers into the form of the value sense data described above. That is, the correct value sense data has the same structure as the value sense data.

The conversion model learning unit 21 learns a conversion model (for example, a neural network or the like) for calculating value sense data (for converting action characteristic data into value sense) by using machine learning or the like. That is, a conversion model is learned so that the conversion model learning unit 21, when the action characteristic data stored in the action characteristic storage unit 211 for each user is input, derives correct value sense data stored in the correct value sense storage unit 212 for the user. A conversion model learning unit 21 stores (a parameter of) the learned conversion model in the conversion model storage unit 213.

Note that the action characteristic data or the correct value sense data of the users A and user B who are the parties of the data circulation (buying and selling the data) in the present embodiment may not be stored in the action characteristic storage unit 211 or the correct value sense storage unit 212.

The value sense calculation unit 22 calculates value sense data of each user (in the present embodiment, user A and user B) who is the party of data circulation by inputting action characteristic data of each user to a learned conversion model. The action characteristic data of each user may be acquired by a method similar to the action characteristic data stored in the action characteristic storage unit 211.

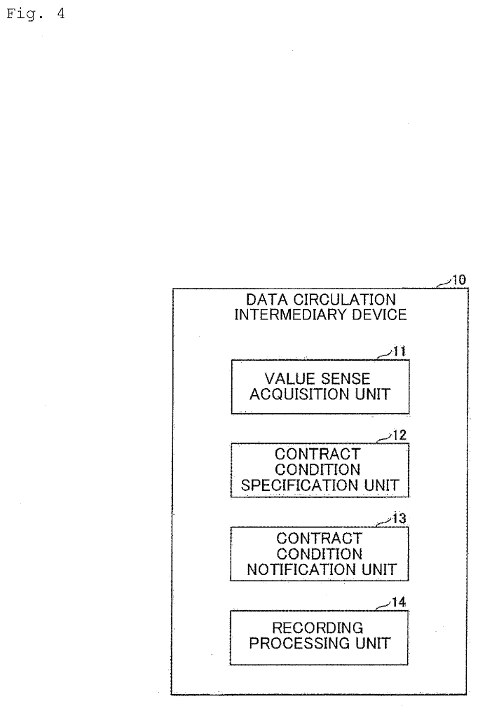

FIG. 4 is a diagram showing an example of a functional configuration of the data circulation intermediary device 10 according to the embodiment of the present invention. Referring to FIG. 4, the data circulation intermediary device 10 includes a value sense acquisition unit 11, a contract condition identification unit 12, a contract condition notification unit 13, a recording processing unit 14, and the like. These units are implemented by processing that one or more programs installed in the data circulation intermediary device 10 cause a processor 104 to execute.

The value sense acquisition unit 11 acquires value sense data of each user who is a party of data circulation. The value sense data may be acquired from, for example, a URL designated by the value sense calculation device 20 or the user terminal 30.

The contract condition identification unit 12, based on the value sense data of each user acquired by the value sense acquisition unit 11 and the data information of the target data (herein after, referred to as “target data information”), by calculating reliability score of the contract condition for each of a plurality of kinds of contract conditions of prepared in advance (default), identifies a contract condition whose reliability score is greater than or equal to a threshold.

The data information includes, for example, parameters such as a data type, a data amount, and a data use content (data usage). The contract conditions include parameters such as “ledger type”, “consideration”, “deposit”, and the like.

The “ledger type” is the type of ledger of the storage destination (recording destination) of the contract content (contract condition or data information approved by both users). In the present embodiment, the value of the “ledger type” is one of three types of “centralized ledger”, “consortium type distributed ledger”, and “public type distributed ledger”. Since the characteristics of the ledgers are distinct depending on the functions of the ledgers, it is considered that these three kinds of ledgers can have different characteristics. By utilizing the difference in characteristics, it is expected that the reliability of the contract is enhanced.

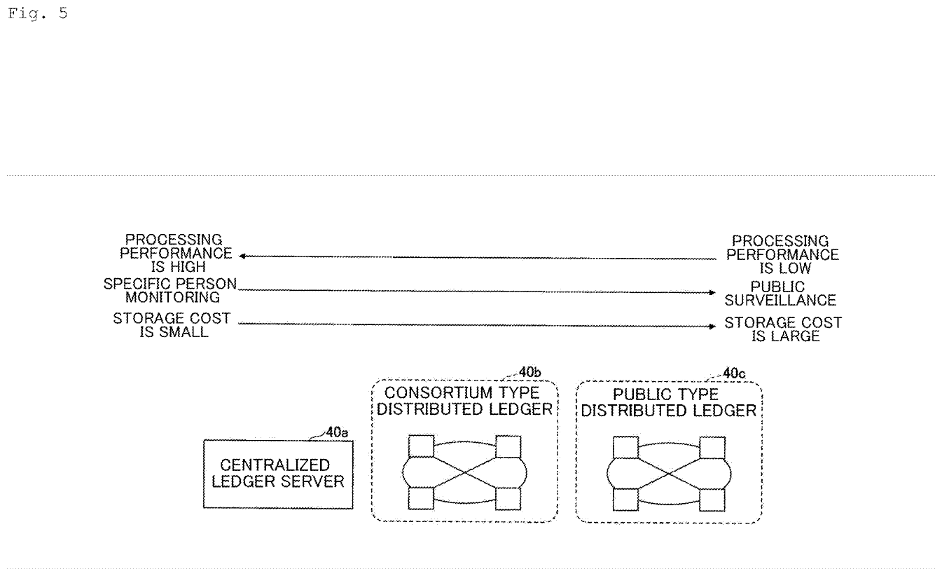

FIG. 5 is a diagram showing differences of three types of ledgers. FIG. 5 shows differences among the three types of ledgers in terms of processing performance, supervisors, and storage cost.

Note that the distributed ledger has a smart contract. Therefore, a smart contract may be used in the distributed ledger.

The term “consideration” is the price of the target data.

The “deposit” is the amount of the security money that the partner can automatically receive when the contract fails.

The contract condition notification unit 13 notifies the contract condition calculated by the contract condition identification unit 12 to a user terminal 30 of the party.

When receiving information indicating approval to the contract condition from each user terminal 30 of the circulation source or circulation destination of data, the recording processing unit 14 records contract content including the contract condition in a ledger of the “ledger type” of the contract condition.

In order to identify a contract condition whose reliability score is greater than or equal to a threshold, the contract condition identification unit 12 uses, for example, a learned reliability calculation model. The reliability calculation model is a model for outputting one reliability score (for example, a neural network or the like), by inputting one value sense data and one contract condition. The reliability score in this case indicates a level of possibility that a user of the value sense data complies with the contract condition. The contract condition identification unit 12 inputs value sense data of the user and candidates of the contract condition into a reliability calculation model for each candidate of the contract condition and each of the user A and the user B, thereby calculates reliability scores of the user A and the user B for each candidate of the contract condition. The contract condition identification unit 12 adopts the smaller one of the reliability scores of the user A and the user B calculated for each candidate of the contract condition as a reliability score for the candidate. As a result, a reliability score is obtained for each candidate of the contract condition. The contract condition identification unit 12 selects one contract condition from among candidates of contract conditions whose reliability score is greater than or equal to a threshold, and notifies the user terminal 30 of the selected contract condition and the reliability score of the contract condition. The contract conditions may be selected at random, or may be selected based on a predetermined rule (for example, a maximum reliability score, or the like).

The threshold value for the reliability score may be dynamically determined (calculated) by the contract condition identification unit 12 based on the target data information. For example, the threshold value may be increased as the data amount of the target data is larger, or when the target data includes private information (personal information or the like), the threshold value may be increased. An appropriate threshold depending on the data information may be determined based on experiments or the like.

Such a reliability score model can be constructed as follows, for example.

First, an experiment is made as to how much a person of certain value sense data is reliable, and a correspondence relation between the value sense data and the reliability score is obtained. In the experiment, for example, the reliability score of each subject may be determined by acquiring value sense data for the subject and performing a questionnaire about a contract of data circulation for the subject. Note that, the correspondence relation indicates a correspondence relation between the value sense data and the reliability score when there is no contract condition.

Further, data on the percentage probability of a change in action (from compliance of the contract to cancellation of the contract, or vice versa) of a person of certain value sense data, when the contract conditions are changed, is obtained through experiments, and the results of these experiments are reflected in the two-dimensional correspondence between the value sense data and the reliability score to create a three-dimensional correspondence that includes the contract conditions. As a result, a reliability score for the combination of the value sense data and the contract condition is obtained. The reliability score for the combination of the certain value sense data and the certain contract condition is obtained by correcting the reliability score for the value sense data to a value obtained by adding the contract condition. For example, if the probability that the person of the value sense data changes his/her action by conversion applied to the contract condition is high, the reliability score may be corrected to be higher.

The reliability calculation model may be learned by using the correspondence relation between the combination of the value sense data and the contract condition, and the reliability score created in this way as training data.

In the present embodiment, the reliability calculation model may be tuned so that weighting is applied to each of the parameters (in the present embodiment “the consistency tendency of action”, “the degree of influence from reputation from others”, “the degree of influence from monetary merits or demerits”, and the like).

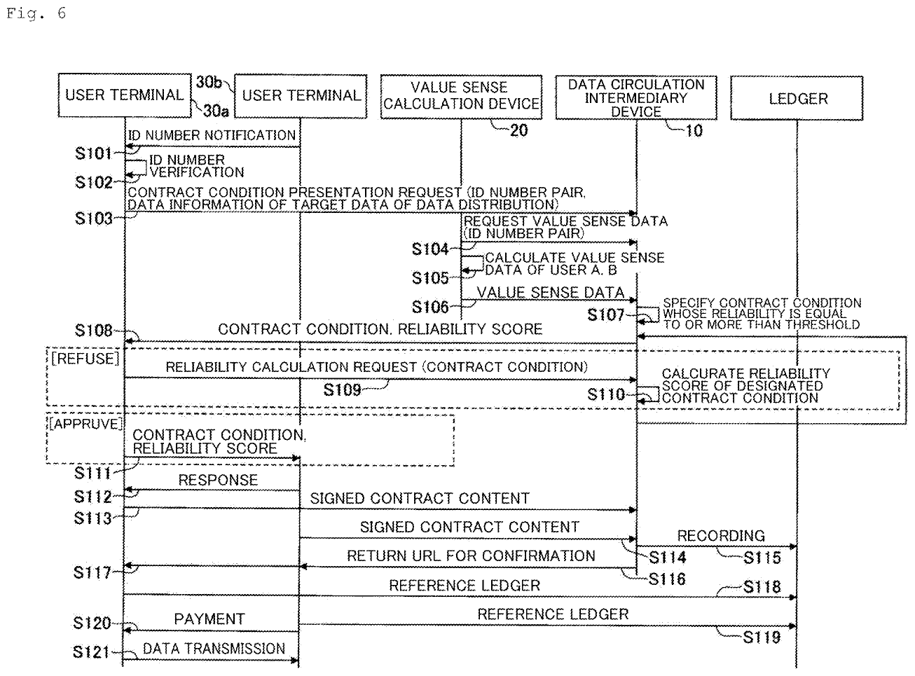

Hereinafter, processing steps executed in the data circulation system will be described. FIG. 6 is a sequence diagram explaining an example of processing steps which is executed in the data circulation system.

In step S101, the user terminal 30b transmits the ID number of the user B to the user terminal 30a of the circulation source of the target data in response to an instruction by the user B. Note that the ID number is an identifier of the user.

Subsequently, the user A or the user terminal 30a verifies the ID number of the user B (S102). For example, the user A may acquire and verify the identity certificate of the user B (for example, an electronic certificate, or the like), or the user terminal 30a may electronically verify the DID (Decentralized ID) or the like.

Once the validity of the ID number of the user B is confirmed, the user terminal 30a transmits a presentation request of contract condition including a pair of the ID number of user A and the ID number of the user B (herein after, referred to as “ID number pair”), and target data information to the data circulation intermediary device 10 (S103). Note that the target data information may be input to the user terminal 30a by the user A. Alternatively, for example, in step S101, the target data information may be transmitted from the user terminal 30b to the user terminal 30a. In this case, the target data information is input to the user terminal 30b by the user B.

When a contract condition calculation request is received by the data circulation intermediary device 10, the value sense acquisition unit 11 of the data circulation intermediary device 10 designates an ID number pair and requests value sense data of each of the user A and the user B to the value sense calculation device 20 (S104).

The value sense calculation unit 22 of the value sense calculation device 20 inputs action characteristic data of each of the user A and the user B to a learned conversion model in response to a request from the data circulation intermediary device 10, and thereby calculates value sense data of each of the user A and the user B (S105). Note that the action characteristic data of each of the user A and the user B may be acquired from the action characteristic holding device 50 or each user terminal 30 or the like at the timing of step S105, or may be stored in advance in the value sense calculation device 20. Further, the value sense calculation unit 22 may calculate in advance the value sense data of each user such as the user A and the user B, to store the value sense data in the value sense calculation device 20. In this case, it is not necessary to calculate the value sense data at the timing of step S105.

Then, the value sense calculation unit 22 transmits the value sense data of each of the user A and the user B to the data circulation intermediary device 10 (S106). The value sense acquisition unit 11 of the data circulation intermediary device 10 receives the value data.

When the value sense data of each of the user A and the user B is received by the value sense acquisition unit 11, a contract condition identification unit 12 identifies, based on the value sense data, one contract condition whose reliability score is greater than or equal to a threshold (S107). Note that the threshold value changes according to the target data information. When there is no candidate for a contract condition whose reliability score is greater than or equal to a threshold, the contract condition identification unit 12 may identify the contract condition whose reliability score is the maximum. Alternatively, the contract condition identification unit 12 may search for a contract condition whose reliability score is greater than or equal to a threshold by gradually changing values of any or all parameters of the contract condition, and identify the contract condition whose reliability score is greater than or equal to the threshold.

Then, the contract condition identification unit 12 transmits a response including the identified contract condition and the reliability score of the contract condition to a user terminal 30a which is the transmission source of the presentation request of the contract condition (S108). The user terminal 30a outputs, for example, the contract condition and the reliability score to a display device (display) of the user terminal 30a. As a result, the user A can confirm the contract condition and the reliability score. Based on the contract condition and the reliability score, the user A determines whether to approve or reject the contract condition (that is, whether to approve the circulation of the target data). When rejecting the contract condition, the user A inputs a contract condition obtained by adding a change to a part or all of parameters of the contract condition (herein after referred to as “changed contract condition”) to the user terminal 30a.

When the user A performs input indicating rejection and input of a changed contract condition to the user terminal 30a, the user terminal 30a transmits a calculation request of a reliability score including the changed contract condition to the data circulation intermediary device 10 (S109). When receiving the calculation request, the contract condition identification unit 12 of the data circulation intermediary device 10 inputs the changed contract condition included in the calculation request and the value sense data of each of the user A and the user B to the reliability calculation model, and calculates a reliability score corresponding to the changed contract condition (S110). Subsequently, step S108 and subsequent steps are repeated. In this case, in step S108, the reliability score calculated in step S110 and the changed contract condition are transmitted to the user terminal 30a. Note that the changed contract condition is not always the contract condition which is the most preferable content condition for the user A. If the reliability score for the most preferred contract condition for the user A is low, the probability that the contract condition is not approved or observed by the user B is high. Therefore, the user A needs to determine the changed contract condition in consideration of the reliability score.

Following step S108 executed for the first or second time, when the user A performs input indicating approval to the contract condition to the user terminal 30a, the user terminal 30a transfers the contract condition and the reliability score to the user terminal 30b (S111). Note that when the target data information is unknown for the user terminal 30b (for example, when the target data information is input to the user terminal 30a by the user A or the like), the user terminal 30a may also transfer the target data information to the user terminal 30b in step S111.

The user terminal 30b outputs, for example, the contract condition and the reliability score to a display device (display) of the user terminal 30b. As a result, the user B can confirm the contract condition and the reliability score. Based on the contract condition and the reliability score, the user B determines whether to approve or reject the contract condition (that is, whether to approve the circulation of the target data). When the user B performs input indicating response (approval or rejection) to the user terminal 30b, the user terminal 30b transmits response approval or rejection indicating input by the user B to the user terminal 30a (S112). Note that, when rejecting the contract condition, the user B inputs the contract condition obtained by adding a change to part or all of parameters of the contract condition (herein after referred to as “changed contract condition”) to the user terminal 30b. In this case, the response transmitted from the user terminal 30b to the user terminal 30a in step S112 includes a changed contract condition.

When the user terminal 30a receives the response, the user terminal 30a branches the processing according to the response. That is, when the response indicates rejection, the user terminal 30a executes step S109. In this case, the user terminal 30a includes a changed contract condition included in a response received from the user terminal 30b in a calculation request of a reliability score to be transmitted to the data circulation intermediary device 10. As a result, step S109 and the subsequent steps are repeated until the contract conditions approved by both the user A and the user B are obtained. Note that, when the number of times of repetition of step S109 and the subsequent steps reaches a predetermined number of times, the circulation of the target data may be not performed.

On the other hand, when the response from the user terminal 30b indicates approval, the user terminal 30a transmits the contract content to which the electronic signature of the user A is given (signed contract content) to the data circulation intermediary device 10 (S113). Note that a contract content is data including the target data information and the contract condition (the contract condition approved by both user A and the user B). The user terminal 30b transmitting a response indicating approval to the user terminal 30a, transmits the contract content to which the electronic signature of the user B is given (signed contract content) to the data circulation intermediary device 10 (S114). Note that the signed contract contents from each user terminal 30 are examples of information indicating approval to contract content (contract condition included in contract content) by each user of the circulation source or circulation destination.

The recording processing unit 14 of the data circulation intermediary device 10 records the signed contract contents in any ledger only when the signed contract contents are received from both the user terminal 30a and the user terminal 30b (S115). As a result, each signed contract content constitutes part of the blockchain managed in the ledger. Since each signed contract content is recorded as part of the blockchain, the possibility of falsification of each signed contract content can be reduced. In this case, when the contract condition includes the “ledger type”, as in the present embodiment, the recording processing unit 14 recodes each signed contract content in a ledger corresponding to the “ledger type” of the contract condition included in the contract content.

Then, the recording processing unit 14 transmits a URL for confirmation of (for access to) each signed contract content recorded in the ledger to the user terminal 30a and the user terminal 30b respectively (S116, S117).

Each of the user terminal 30a and the user terminal 30b accesses the URL to refer to the contract content recorded in the ledger (S118, S119). In this case, the user terminal 30a and the user terminal 30b may verify whether the contract content transmitted in step S113 or S114 matches the contract content recorded in the ledger (that is, whether the contract is not falsified). When the transmitted contract content does not match the contract content recorded in the ledger, the user terminal 30a and the user terminal 30b may perform output for notifying the user A or the user B of the result. In this case, the user A and the user B do not circulate the target data.

When the contract content transmitted by each user terminal 30 matches the contract content recorded in the ledger, a consideration determined in the contract condition is paid from the user terminal 30b (from the user B) to the user terminal 30a (to the user A) (S120). The target data is transmitted from the user terminal 30a (from the user A) to the user terminal 30b (to the user B) (S130). If the payment of the consideration is not executed, the deposit determined in the contract condition is paid to the user A. When the transmission of the target data is not executed, the deposit determined in the contract condition is paid to the user B.

According to the present embodiment, it is expected that the following contract conditions are identified or derived in a contract for providing data from the user A to the user B.

When the “consistency tendency of action” of the user B is lower than that of the user A, it is considered that the possibility of observing the contract is lower than the possibility expected by the user A. Therefore, it is assumed that a public type distributed ledger having the eyes around is selected as the “ledger type” rather than a centralized ledger. That is, the “consistency tendency of action” is to measure a character of a person regarding how much the person dislikes self-contradiction. Therefore, the “consistency tendency of action” is regarded as indicating how much the “consistency tendency of action” is contradictory to the fact that the contract is concluded, and the “ledger type” is selected in this manner. Persons have different degrees with respect to “observing rules”. By comparing differences in the degree, the accuracy can be further improved.

When “the degree of influence from reputation from others” of the user B is lower than that of the user A, it is unlikely that presence or absence of the eyes around the contract enhances his compliance to the contract; therefore, it is assumed that the deposit and compensation are adjusted to reflect the monetary influence on the contract contents.

When both of the value sense data of the user A and the user B have high “consistency tendency of action” and a tendency to observe agreement by himself/herself can be assumed, sufficient contract compliance is expected even in a centralized ledger, and therefore, it is assumed that the centralized ledger is selected as the “ledger type”.

When both the value sense data of the user A and the user B have high “consistency tendency of action” and have a tendency to observe agreement by himself/herself, yet data to be exchanged is sensitive, it is assumed that a ledger having the eyes around such as a consortium type or a public type is selected as the “ledger type” instead of a centralized ledger.

As described above, according to the present embodiment, a contract condition is identified in consideration of the value sense of the parties concerned in terms of the data circulation, and when both the parties concerned have approved the contract condition, the contract condition is settled. Therefore, the possibility that the data circulation is abused can be reduced. As a result, circulation of personal data in the future can be smoothly executed.

In the present embodiment, the data circulation intermediary device 10 and the value sense calculation device 20 are examples of a data circulation support apparatus. The contract condition identification unit 12 is an example of an identification unit. The value sense calculation unit 22 is an example of a calculating unit.

Although embodiments of the present invention have been described in detail above, the present invention is not limited to the specific embodiments described above, and various modifications and changes can be made within the scope of the gist of the present invention described in the claims.

### REFERENCE SIGNS LIST

10 Data circulation intermediary device
11 Value sense acquisition unit
12 Contract condition identification unit
13 Contract condition notification unit
14 Recording processing unit
20 Value sense calculation device
21 Conversion model learning unit
22 Value sense calculation unit
30a User terminal
30b User terminal
40a Centralized ledger server
40b Consortium type distributed ledger
40c Public type distributed ledger
50 Action characteristic holding device
100 Drive device
101 Recording medium
102 Auxiliary storage device
103 Memory device
104 Processor
105 Interface device
211 Action characteristic storage unit
212 Correct value sense storage unit
213 Conversion model storage unit
B Bus

1. A data circulation support apparatus comprising:
a memory; and
a processor configured to execute
calculating a score indicating reliability of a contract condition related to circulation of data based on information indicating a sense of value related to contract compliance of each of a user of a circulation source of the data and a user of a circulation destination of the data, and identifying a contract condition whose score is greater than or equal to a threshold; and
recording the contract condition in a ledger upon receiving information indicating approval to the contract condition by the user of the circulation source or the circulation destination.

2. The data circulation support apparatus according to claim 1, wherein the contract condition includes a type of a ledger that is a recording destination of the contract condition, and
wherein the processor records the contract condition in a ledger related to the type included in the contract condition.

3. The data circulation support apparatus according to claim 1, wherein the threshold value varies depending on information related to the data.

4. The data circulation support apparatus according to claim 1, the processor is further configured to execute
calculating information indicating the sense of value of a user based on action characteristic data of the user,
wherein the processor identifies the contract condition based on the information indicating the sense of value calculated for each user of the circulation source or the circulation destination.

5. A data circulation support method, executed by a computer including a memory and a processor, the method comprising:
calculating a score indicating reliability to a contract condition related to circulation of data based on information indicating a sense of value related to contract compliance of each of a user of a circulation source of the data and a user of a circulation destination of the data, and identifying a contract condition whose score is greater than or equal to a threshold; and
recording the contract condition in a ledger upon receiving information indicating approval to the contract condition by the user of the circulation source or the circulation destination.

6. A non-transitory computer-readable recording medium having computer-readable instructions stored thereon, which, when executed, cause a computer to function as the data circulation support apparatus according to claim 1.
